(19) United States
(12) Patent Application Publication
(10) Pub. No.: US 2003/0196752 A1
(43) Pub. Date: Oct. 23, 2003

(54) Epoxy tacking for optoelectronic device placement

(76) Inventors: Joseph Michael Freund, Fogelsville, PA (US); John Michael Geary, Longswamp Township, PA (US)

Correspondence Address: Wendy W. Koba, PO Box 556, Springtown, PA, 18081, US

(21) Appl. No.: 10/123,953

(22) Filed: Apr. 17, 2002

(51) Int. Cl. C09J 1/00

(52) U.S. Cl. 156/330

(57) ABSTRACT

A process for attaching one or more optoelectronic components to an optical submount uses an epoxy to first tack each component to its associated bondpad site. The epoxy has a sufficient strength to temporarily hold each component in place as various ones of the components are positioned, moved, etc. Once all of the components are “tacked” into position, the arrangement is heated to the solder reflow temperature, where the molten solder will displace the epoxy and form the final physical and electrical connection between the components and the submount. Preferably, the solder reflow temperature is sufficient to cure the epoxy, which then forms an inert substance that will not interfere with the performance of the final system.

### TECHNICAL FIELD

The present invention relates to an epoxy tack process and, more particularly, to the use of an epoxy tack process to temporarily “fix” the placement of optoelectronic devices on a substrate prior to a solder-based bonding process.

### BACKGROUND OF THE INVENTION

In order for optoelectronics technology to have wide applications in consumer and telecommunication products, it is desirable to reduce the assembly cost and to improve the reliability of the products. For low-cost optical assembly, passive alignment using solder bonding of the components to a substrate is an attractive process. A reasonably accurate alignment between on-substrate active optical devices (such as a laser, LED or photodiode) and an optical fiber (or any other suitable optical transmission path) can be achieved by utilizing the well-known solder self-alignment process, or by using a convenient alignment fixture, such as a substrate including one or more alignment V-grooves.

Various solder alloys are used in the optoelectronics industry for bonding the optoelectronic devices to submounts within the package housings. Some of the more common solder materials include aluminum nitride, beryllium oxide, copper-tungsten and silicon. During conventional optoelectronic device die-bonding processes, the solder is heated to approximately 300° C. (to melt the solder), enabling the molten solder to “wet” the submount and optoelectronic device metallization layers. When cooled, the solder resolidifies to form a metallurgical bond between the device and the submount. It is known that a die-bonded optoelectronic device-to-submount assembled in this manner is mechanically and electrically robust and reliable if the coefficients of thermal expansion (CTB) are matched to within a few parts-per-million per degree Celsius, and if proper metallurgy is selected at the solder joint interfaces.

One particularly type of bonding, referred to as “self-alignment”, is based upon solder bump flip-chip technology, and has been employed to reduce die bonding accuracies from tens of micrometers to about one micrometer. In this “self-alignment” process, small (approximately 75 μm diameter) solder bumps are placed around the periphery of the opto electronics device. These solder bumps serve to “self-align” the device (i.e., through surface tension) as the solder is heated to a molten state and during reflow of the solder. When coupling light between optical fibers (or waveguides) and optoelectronic devices, the self-alignment process eliminates the need for actively adjusting the position of the device relative the fiber or waveguide when the solder is molten.

During the initial steps of placing the optoelectronic devices on the submount, a “tacking” process has been used to temporarily hold the devices in place until the solder reflow step. This tacking step has historically been accomplished by using a thermocompression process where the solder is heated to a temperature where it becomes soft, but does not melt. While the use of thermocompression is successful in temporarily holding the components in place, the temperature cycling (i.e., cycling between room temperature and the sorer softening temperature a multiple number of times) has been found to affect the integrity of the solder, at times increasing its melting point and making the reflow/bonding process less robust. In particular, the temperature cycling has been found to accelerate diffusion, promoting voids that will degrade the electrical, thermal and strength performance of the solder joint.

### SUMMARY OF THE INVENTION

The present invention relates to an epoxy tack process and, more particularly, to the use of an epoxy tack process to temporarily “fix” the placement of opto electronic devices on a substrate prior to a solder-based bonding process.

In accordance with the present invention, a small amount of epoxy is first disposed on a solder-covered bond pad site, then an opto electronic component is set into the epoxy, where solder volumes in the range of 0.01-0.10 microliters have been found to work best. In a preferred embodiment, the same “pick and place” equipment used to position the components is used to deposit the epoxy, allowing for multiple epoxy deposit and component tack operations to be performed automatically. The epoxy is uncured and is able to temporarily hold the components in place until the solder reflow process is initiated. Since no heating is required to fix the components (in contrast to the prior art thermocompression process), the integrity of the solder is maintained during the entire component tacking process. Upon initiation of the solder reflow, the molten solder will displace the epoxy from the bond pad sites, thus the epoxy does not affect the solder joint strength or any other characteristic of the final solder joint connection to the optoelectronic components.

In a preferred embodiment of the present invention, the chosen epoxy exhibits one or more of the following characteristics: (1) extended pot life (to allow for increased handling and process time for manufacturing); (2) thixotropic consistency (to prevent wicking into unwanted areas); (3) unfilled (to prevent parts from being stood off by grit, which would effect planarity); (4) thermally curing at the solder reflow temperature (to transform the epoxy to an inert substance); and (5) a dielectric (to prevent electrical Other and further applications and advantages of the present invention will become apparent during the course of the following discussion and by reference to the accompanying drawings.

### BRIEF DESCRIPTION OF THE DRAWINGS

Referring now to the drawings,

FIG. 1 contains a flowchart illustrating an exemplary process for using the epoxy tacking of the present invention; and

FIG. 2 illustrates an exemplary optical submount, including various bondpad sites for optoelectronic devices, which may use the epoxy tacking process of the present invention.

### DETAILED DESCRIPTION

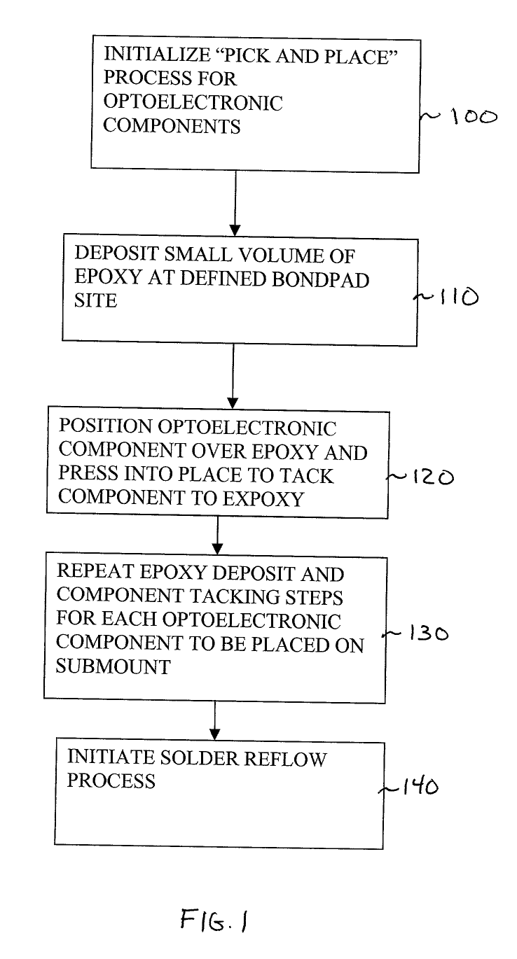

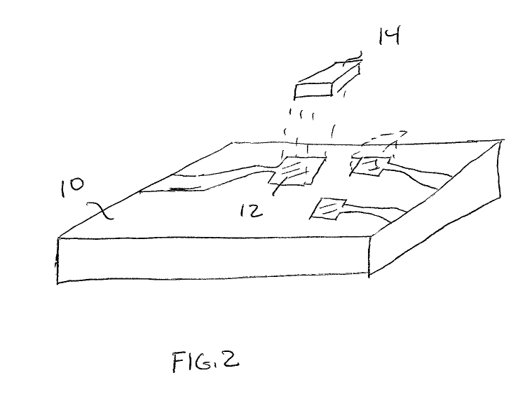

A flowchart illustrating an exemplary process sequence for utilizing the epoxy tacking method of the present invention in contained in FIG. 1. The process is used to temporarily fix one or more opto electronic components into position on a submount structure prior to performing the solder reflow step that will permanently bond (both mechanically and electrically) the components to the submount. FIG. 2 illustrates, in an exploded view, one such submount including a plurality of bondpad sites and the various components that are to be attached to the bondpad sites. Each bondpad site has been previously processed to be coated with a sufficient amount of the solder material that will be used for the final electrical connection to the optoelectronic component.

Referring back to FIG. 1, the first step in this exemplary sequence of the manufacturing process is to initialize a “pick and pkce” system (step 100) that will be used to both deposit the epoxy and position the optoelectronic components. It is to be understood that various systems, both automated and manual, may be used to perform the steps of depositing the epoxy and positioning the optoelectronic components and the use of a “pick and place” system is considered to be exemplary only, albeit a preferable alternative for high volume production situations.

The next step in the process (step 110) is to deposit a small volume of epoxy (e.g., 0.01-0.10 microliters) on a first defined bondpad site (such as bondpad site 12 of submount 10 of FIG. 2). Once the epoxy is in place, the optoelectronic component (such as laser 14 of FIG. 2) is positioned over and pressed into the epoxy (step 120). The epoxy will firmly hold the component in place on the submount, but since no heating process was used in the tacking operation, the solder on the bondpad will not be affected. The process of depositing epoxy and tacking the opto electronic components continues (step 130) until all of the necessary components have been positioned on the submount. It is to be understood that the sequence of operations is not important to the epoxy tacking process of the present invention. That is, each epoxy tack may first be deposited, then all of the components placed in the proper locations.

Once all of the components are in place, the entire arrangement is heated to the solder reflow temperature (e.g., approximately 300° C., with a reflow temperature of 278° C. used with a convention AuSn solder) to initiate the solder bonding process (step 140). As will be discussed below, an advantage of the epoxy tacking process of the present invention is that once the solder becomes molten, it will displace the epoxy from the bondpad site, without also displacing the optoelectronic component. That is, the molten solder will move the epoxy out of position and bond to the optoelectronic component in place of the epoxy tack. In systems utilizing a solder bump self-alignment process, as discussed above, the epoxy tack step can be used to crudely position the optical component, since the following solder reflow step will automatically provide the necessary alignment, through surface tension, between the component and the remainder of the system. Preferably, the material composition of the epoxy is chosen to thermally cure at the reflow temperature, thus forming an inert substance that will not interfere with the subsequent operation of the optoelectronic system. Epotec H54, supplied by Epoxy Technology, is one such epoxy that may be used.

Various other properties of selected epoxy material have been found to be advantageous for use in the process of the present invention. For example, it is preferred to use an (uncured) epoxy with an extended pot life (such as several hours), to allow for increased handling and process time (i.e., to move, remove and/or reposition various misplaced optical components, among other reasons). A thixotropic epoxy is preferred, even though only a small volume of epoxy is required, to prevent any wicking of the epoxy into unwanted areas prior to the solder reflow step (which automatically displaces and cures the epoxy). Preferably, the epoxy is “unfilled”, containing no grit or other matter that may remain on the bondpad surface during or after the solder reflow process. Moreover, a dielectric material is preferred so that there is little or no chance of the epoxy affecting the electrical operation of the system. Various epoxy materials may exhibit one ore more of these properties and are therefore useful as a tacking material for the inventive process.

Although illustrative preferred embodiments have been described herein in detail, it should be noted and will be appreciated by those skilled in the art that numerous variations may be made within the scope of this invention without departing from the principles thereof. Various terms and expressions have been used herein as terms of description and not terms of limitation. There is no intention to use the terms or expressions to exclude any equivalents of features shown and described, or portions thereof. Hence, it is to be understood that the scope of the present invention is intended to be limited only by the language of the claims as included hereinbelow.

What is claimed is:

1. A method of attaching an optoelectronic component to a solder bondpad on an optical submount, the method comprising the steps of:
a) depositing a small volume of uncured epoxy on a solder bondpad site formed on an optical submount;
b) pressing an optoelectronic component into said epoxy to temporarily fix said optoelectronic component to said optical submount;
c) heating the optical submount to a temperature sufficient for solder reflow so that molten solder displaces the small volume of uncured epoxy and bonds to the optoelectronic component.

2. The method as defined in claim 1 wherein steps a) and b) are repeated for a plurality of bondpad sites and a plurality of optoelectronic components to be positioned on a single optical submount.

3. The method as defined in claim 1 wherein in performing step c), the optical submount is heated to temperature that is sufficient to both reflow the solder and cure the epoxy.

4. The method as defined in claim 3 wherein the submount is heated to a temperature of approximately 300° C.

5. The method as defined in claim 3 wherein in performing c), a AuSn solder is used and the submount is heated to a temperature of 278° C.

6. The method as defined in claim 1 wherein in performing step a), an unfilled epoxy is used.

7. The method as defined in claim 1 wherein in performing step a), a thixotropic epoxy is used.

8. The method as defined in claim 1 wherein in performing step a), an epoxy with a pot life of several hours is used.

9. The method as defined in claim 1 wherein in performing step a), a dielectric epoxy is used.

10. The method as defined in claim 1 wherein in performing steps a) and b) an automated process is used.

11. The method as defined in claim 9 wherein a “pick and place” process is used.

12. The method as defined in claim 1 wherein in performing step a) a volume of epoxy in the range of 0.01-0.10 microliters is deposited.
